(19) United States
(12) Patent Application Publication
(10) Pub. No.: US 2010/0290258 A1
(43) Pub. Date: Nov. 18, 2010

(54) Inverter Topology For Improved Efficiency And Reduced Harmonic Distortion

(75) Inventor: Mark Sullivan, Houston, TX (US)

Correspondence Address: BRACEWELL & GIULIANI LLP, P.O. BOX 61389, HOUSTON, TX, 77208-1389, US

(73) Assignee: CapTech Development Corporation, Houston, TX (US)

(21) Appl. No.: 12/779,676

(22) Filed: May 13, 2010

Related U.S. Application Data
(60) Provisional application No. 61/178,981, filed on May 17, 2009.

(51) Int. Cl. H02M 7/42

(52) U.S. Cl. 363/71

(57) ABSTRACT

An inverter circuit for generating an AC signal from a DC input is described herein. The inverter comprises a primary inverter for generating a first portion of a signal, the primary inverter using switches that when actuated efficiently produce the first portion of the signal, the first portion of the signal being an approximation of a sine wave, the approximation of the sine wave having an error component; a secondary inverter for generating a second portion of the signal, the secondary inverter using switches to produce a waveform that that attenuates the error component of the first portion of the signal; and combining means such as a transformer which combine the first and second portions of the generated signal to produce a substantially improved approximation of a sine wave. An inverter circuit may further comprise: a filter connected to the transformer for smoothing a residual carrier frequency from the secondary portion of the signal; wherein the filter comprises a rectifier connected to the DC input of the primary inverter.

This application claims priority to and incorporates herein by reference in its entirety U.S. provisional patent application 61/178,981, entitled “Novel Inverter Topology For Improved Efficiency and Reduced Harmonic Distortion, filed on May 17, 2009.

### BACKGROUND OF THE INVENTION

1. Field of the Invention

This application relates generally to inverters and more particularly to inverters that convert, with high efficiency, direct-current electrical power (DC) to alternating-current electrical power (AC) with low signal distortion.

2. Description of the Prior Art

Inverters are critical components for converting direct current (DC) electrical power generated by, e.g., solar power, windmills, power plants, batteries, etc, into alternating current (AC) electrical power that is used to power electronics, motors, for power distribution, etc. Accordingly, inverters are critical components for: load balancing electrical power grids, high voltage power transmission, inter-tie of unsynchronized power grids, uninterruptible power supplies, driving motors, electrical cars, and for portable AC power sources.

One simple and common inverter topology is a pair of switches and a transformer. By connecting the two ends of the transformer's primary winding alternately to a supply of DC current, where the center tap of the winding returns current to the DC power supply, current is made to flow back and forth through the winding, inducing an alternating magnetic field in the transformer core and thus an alternating AC output voltage at the terminals of the transformer's secondary. An arrangement of four switches can convert DC to AC without a transformer. The switches in either of these simple implementations may be mechanical, such as an electro-mechanical oscillator called a “vibrator” or may be solid-state semiconductor switches, such as any of various types of transistors or thyristors, driven by electronic timing circuits. Other simple inverters, especially for very high power applications, are implemented by arranging a DC motor to turn an AC generator. Most modern inverters are based on solid-state semiconductor switches, and generate output waveforms that include a square wave, a modified square wave, and a sine wave. However, inverters based on switches do not naturally produce current having a sine waveform, but rather current with step changes in amplitude as the switches open and close. By varying the parameters of such square pulses, current having an approximation of a sine waveform can be produced. The departure of such an approximation from the ideal may be examined in the time domain or frequency domain. In the frequency domain, the difference between the approximation and the ideal is the total harmonic distortion (THD), i.e., energy at a frequency that is a harmonic of the desired fundamental frequency.

The easiest waveform to produce with simple switches in a square wave. The efficiency of an inverter that produces a square-wave can approach 99%, but the waveform is only a gross approximation of a sine wave and the THD is nearly 50%. The modified square wave adds dead time between output pulses to suppress a third harmonic and can cut the THD to around 30%, but adds significant hardware to the inverter. Inverters that produce sine waves deliver efficiency of 85-95% range. The reduction in comparison to the efficiency of square wave designs is largely due to an increase in switching frequency. Square wave inverters switch at the fundamental frequency of the output waveform—typically 50 or 60 Hertz. Sine wave designs using carrier modulation switch at much higher frequencies, typically 5,000 to 20,000 Hertz. Because the energy lost by a high power solid-state switch is generally more or less a constant amount per change in switch state, increasing the frequency increases losses proportionately. However, pure sine inverters deliver total harmonic distortion of 3% or less, and this low distortion is vital for grid-tie and grid balancing applications.

To overcome the problems with prior art inverters, i.e., to optimize inverter efficiency and simultaneously minimize THD, a multi-level inverter has been implemented. Ideally, the multi-level inverter delivers efficiencies approaching those of a square wave with a THD approaching a pure sine wave inverter. In practice, the multi-level inverter is a complicated device that requires a battery or capacitor stack to supply a plurality of DC voltages. If the battery stack is not employed, the multi-level inverter uses an intermediate DC-DC voltage converter stage employing one or more transformers. In many designs, this first inverter stage operates at high frequencies, reducing efficiency and the multi-level battery stack complicates charging and balancing. Moreover, though multi-level inverters decreases THD as more levels are added, the addition of levels reduces efficiency through switching and capacitive losses. Accordingly, more than two or three levels are not commonly implemented. Overall, because of the cost associated with producing and implementing multi-level inverters, this inverter is not ideal.

### SUMMARY OF THE INVENTION

An inverter circuit for generating an AC output from a DC input is described herein. The inverter comprises a primary inverter for generating a first portion of the input signal, the primary inverter using switches that when actuated produce the first portion of the input signal, the first portion of the input signal being an approximation of a sine wave, the approximation of the sine wave having an error component; a secondary inverter for generating a second portion of the input signal, the secondary inverter using switches in a push/pull configuration to generate a signal with harmonic content that destructively combines with and thus attenuates the undesired harmonic content of the first portion of the input signal to thereby correct the error component of the approximation of the sine wave; and a buck-boost transformer which combines the outputs of the first inverter and the second inverter. An inverter circuit of may further comprise: a filter connected to the transformer for smoothing a residual carrier frequency of the secondary portion of the input signal; wherein the filter comprises a rectifier connected to the primary inverter. The inverter may also employ a second transformer capable of smoothing residual energy at the carrier frequency of the secondary inverter, or may comprise a modified buck-boost transformer, provided with a tertiary winding, and a rectifier, connected to a terminal of the tertiary winding, to smooth a carrier signal from the secondary inverter. Each of the switches may be solid-state transistors, and the secondary inverter may operate at a frequency range of 5 KHz to 20 KHz.

Another embodiment of an inverter circuit for generating a three-phase AC signal from a DC input is also described. The inverter circuit comprises a primary inverter comprising six switches that, when actuated, produce a three-phase set of alternating currents with waveforms which are an approximation of sine waves which approximation having a relatively large error component; a three-phase transformer for receiving the output of the primary inverter, the three phase transformer receiving the primary signal across three primary windings; and a plurality of secondary windings for each phase of the three-phase signal, each phase having at least three secondary windings, each of the three secondary windings having a different turns ratio with respect to the associated primary winding. An inverter circuit may have a primary inverter that is a square wave inverter and primary winding to secondary winding ratios for each phase are primary to a first secondary of each phase 1000:476, primary to a second secondary of each phase 1000:242; and primary to third secondary of each phase 1000:236. The inverter circuit may also have a primary inverter that is a modified square wave inverter and a primary winding to secondary winding ratios for each phase are primary to a first secondary of each phase 1000:521, primary to a second secondary of each phase 1000:268; and primary to third secondary of each phase 1000:268.

### BRIEF DESCRIPTION OF THE DRAWINGS

So that the manner in which the features and advantages of the invention, as well as others, which will become apparent, may be understood in more detail, a more particular description of the invention briefly summarized above may be had by reference to the embodiments thereof, which are illustrated in the appended drawings, which form a part of this specification. It is to be noted, however, that the drawings illustrate only various embodiments of the invention and are therefore not to be considered limiting of the invention's scope as it may include other effective embodiments as well.

FIG. 1A is a block diagram of a basic operation of an inverter circuit according to an embodiment of the invention;

FIG. 1B is a circuit diagram implementing an inverter, the inverter having generic switches according to an embodiment of the invention;

FIG. 1C is a circuit diagram implementing an inverter, the inverter having solid state switches according to an embodiment of the invention

FIG. 2 is a circuit diagram implementing an inverter according to an embodiment of the invention;

FIG. 3A is a graph of a voltage over time, with time expressed in radians, output by a first inverter according to an embodiment of the present invention;

FIG. 3B is a graph of voltage over time, with time expressed in radians, output by a second inverter according to an embodiment of the invention;

FIG. 3C is a graph of an output of a transformer connected to the first and second inverters of FIGS. 3A and 3B;

FIG. 4 is a graph of voltage over time, with time expressed in radians, output by an inverter of FIG. 2;

FIG. 5 is a circuit diagram having a waveform simulator output a correcting waveform to control primary and secondary inverter switches according to an embodiment of the invention;

FIG. 6 is a block diagram of a waveform simulator according to an embodiment of the invention;

FIG. 7 is a schematic flow diagram of a computer program product for correcting an output of a first inverter according to an embodiment of the invention; and

FIG. 8 is a flow diagram of the instructions for a computer program product for correcting an output of a first inverter according to an embodiment of the invention.

### DETAILED DESCRIPTION

The present invention will now be described more fully hereinafter with reference to the accompanying drawings in which embodiments of the invention are shown. This invention may, however, be embodied in many different forms and should not be construed as limited to the illustrated embodiments set forth herein; rather, these embodiments are provided so that this disclosure will be thorough and complete, and will fully convey the scope of the invention to those skilled in the art.

The invention of the claims and drawings, and all equivalent circuits, adds a plurality of waveforms together to generate a close approximation of a sine wave, with the efficiency close to that of a square wave inverter and a THD that is close to a pure sine wave inverter. To do this, a basic circuit includes a primary inverter 10, a secondary inverter 20, a transformer 30, and optionally a filter 40. Primary inverter 10 may generate a square wave or a modified square wave depending upon the application, and provides the bulk of the converted power and this signal is passed on to the combining transformer 30. Like the prior art devices, by actuating, e.g., switches, in the primary inverter to produce a square wave, an EMF is produced with a high THD. Secondary inverter 20 generates an additional signal which is added to the primary signal to correct for the high MD. To do this, the secondary inverter 20 may comprise switches, connected to the primary winding of a transformer 30. The secondary of the transformer is disposed in an electrical series circuit with the output of the primary inverter such that the signals from the primary and secondary inverter are combined as an algebraic sum. Filter 40, which is optional, may be provided to attenuate undesired residual energy at the carrier frequency used by the secondary inverter. In this way, the invention implements a high efficiency, low THD inverter circuit. As one skilled in the art will appreciate, though the block diagram is shown with a primary and secondary inverter, transformer and filter, all of these components may not be necessary to achieve the functions of the invention. A different type of filter or an alternate combining means other than a transformer may be employed. As such, and as discussed below, there may be some embodiments of the invention that do not include filter 40, or embodiments of the invention that do not have a dedicated secondary inverter. Accordingly, though the embodiments discussed herein are given as examples, the configuration of such embodiments should in no way limit the disclosure of the invention or any equivalents thereof.

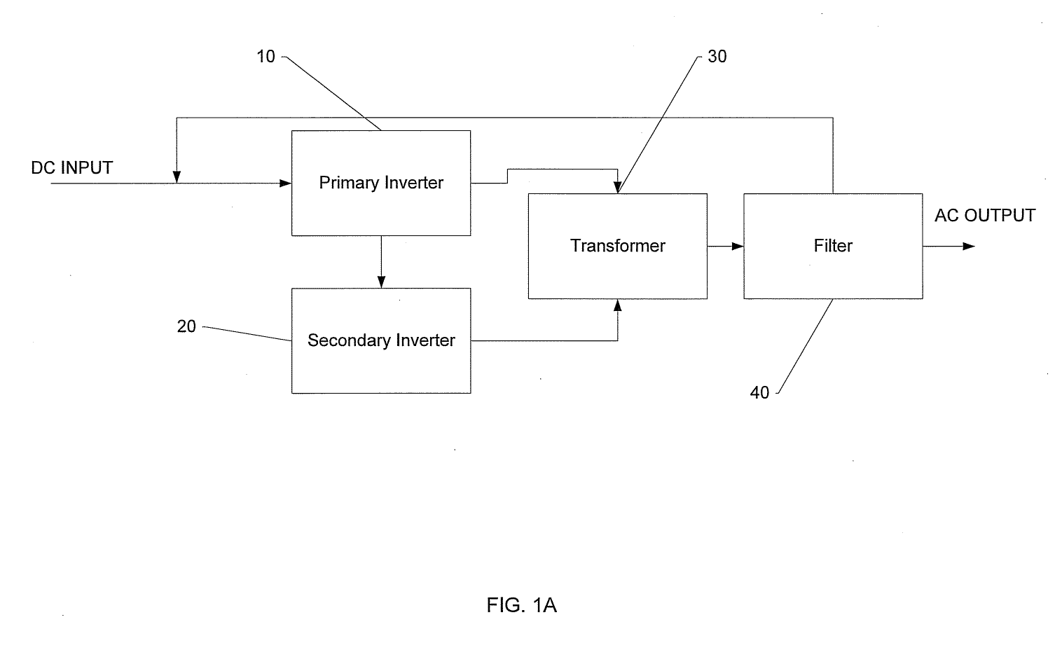

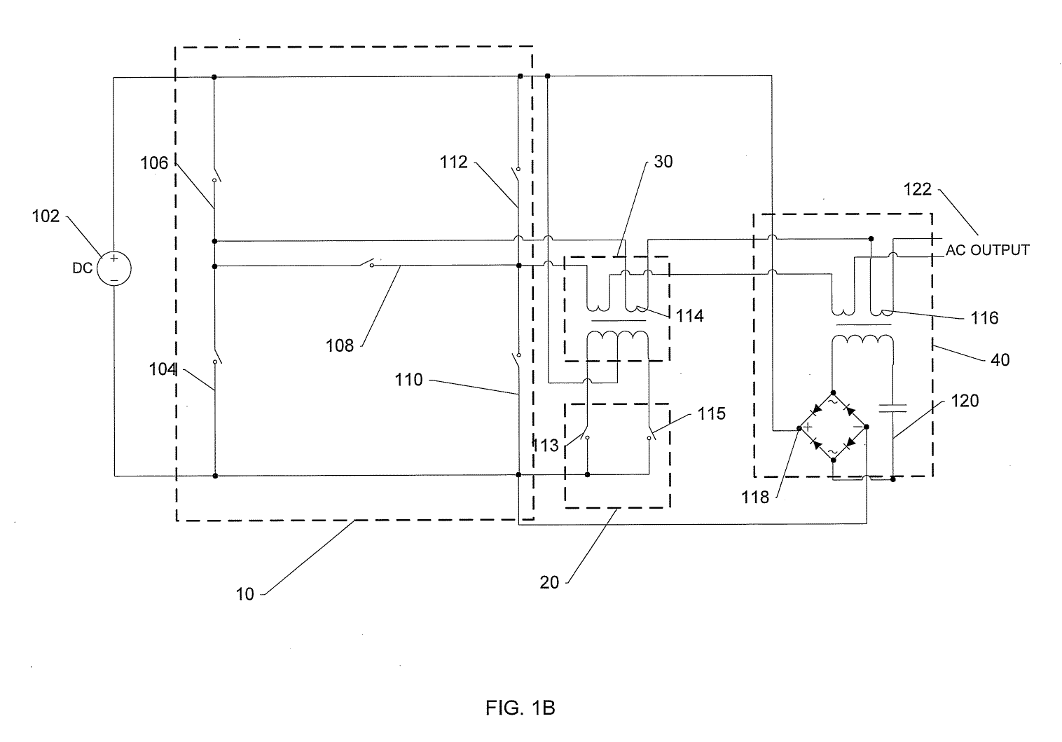

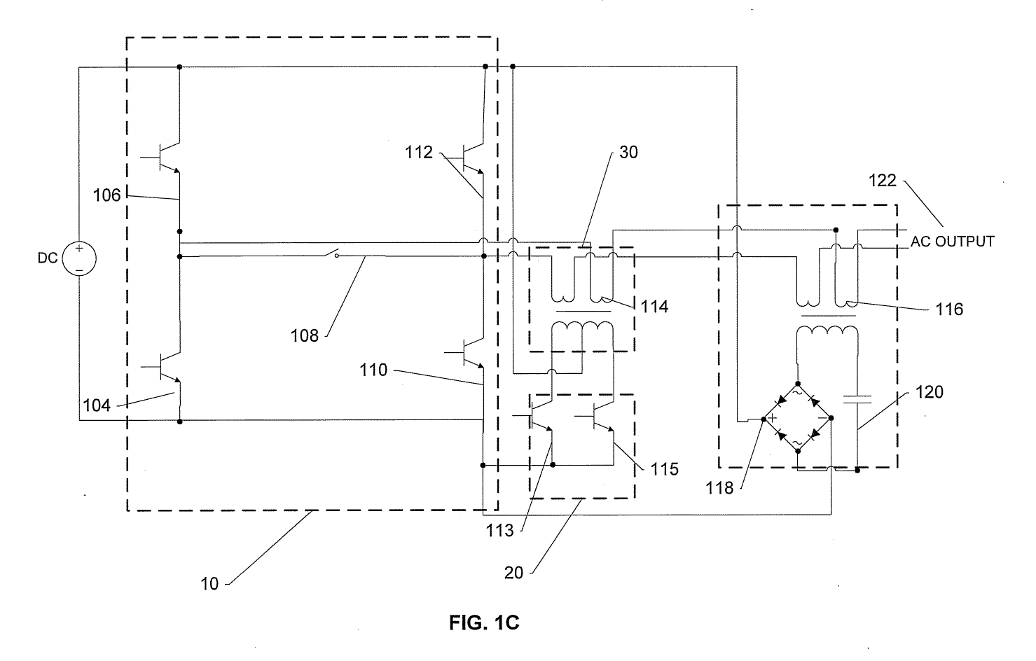

In FIG. 1B, a circuit diagram of an embodiment of the present invention is shown. The circuit diagram consists of a DC power source 102, a plurality of switches 104, 106, 108, 110, 112, 113 and 115, transformers 114 and 116, rectifier 118 and capacitor 120, all of which produces an AC output 122.

Switches 104, 106, 108, 110 and 112 form the primary inverter, while switches 113 and 115 foam the secondary inverter. The primary inverter operates at line frequency, e.g., 60 HZ, and outputs a modified square wave if switch 108 is closed during a zero output period of the waveform. As one skilled in the art will appreciate, as a result of switching, square wave inverter has a duty cycle of approximately 50%. As one skilled in the art will also appreciate, the primary inverter could also be implemented as a multi-level inverter. The secondary inverter is a push pull inverter, and may operate at a higher frequency, with pulse width modulation. For example, the secondary inverter may operate at a frequency of 5 KHz to 20 KHz. Moreover, though shown tapping the primary winding of transformer 114 in a push-pull configuration, the secondary inverter may be implemented as a full-bridge driver together with an untapped transformer primary. Such a configuration would add two more switches to reduce the winding size of the transformer. As one skilled in the art will recognize, though switches, 104, 106, 108, 110, 112, 113 and 115 are shown as generic devices in FIG. 1B, solid state switches may be used, e.g., MOSFET or IGBT transistors such as those available from International Rectifier, Infineon, Ixys, Microsemi, Powerex, and other manufacturers, as shown in FIG. 1C. Depending on the nature of the switches employed, specifically if they include an anti-parallel diode as is typical with IGBT modules, switch 108 may be omitted and its function replaced by simultaneously closing switches 104 and 110 while switchers 106 and 112 remain closed. As can be seen, while the transistors may be pnp-type or npn-type, in the preferred embodiment, the transistors are npn-type so that all carriers in the transistors are electrons. Moreover, while none of the gates in the exemplary IGBT transistors are connected to a drive circuit, one skilled in the art will recognize that the gates are controlled by some drive circuit, such as the waveform simulator (to be discussed below), that can regulate switching timing, e.g., level shifting, isolation, amplification, etc.

Transformers 114 and 116 are also shown in FIG. 1. Transformer 114 is shown as a three winding transformer, with a center-tapped primary, wired to add (boost) or subtract (buck) from the output of the primary inverter to produce the AC output 122. As one skilled in the art will appreciate, as the switches in the secondary inverter are actuated, current flows in different directions through the primary winding of the buck-boost transformer, which in turn produces an AC output, which is summed by the electrical series connection with the output of the primary inverter. Transformer 116, together with rectifier 118 and capacitor 120 form a filter to smooth the output from transformer 114 by reducing the pass-though of the secondary inverter's carrier frequency. The transformer 116 couples the carrier frequency generated by the second inverter to the rectifier 118, which acts as a power sink that removes the carrier frequency and outputs a DC component that is returned to the DC power source 102. In this way, the circuit of the exemplary embodiment produces a high efficiency, low THD signal. As one skilled in the art will appreciate, transformer 116 may be embodied as an additional winding on the core of transformer 114, alleviating the need for the second transformer 116. In such a configuration, the transformer would integrate an additional winding, and this additional secondary winding of the transformer would be connected to the rectifier.

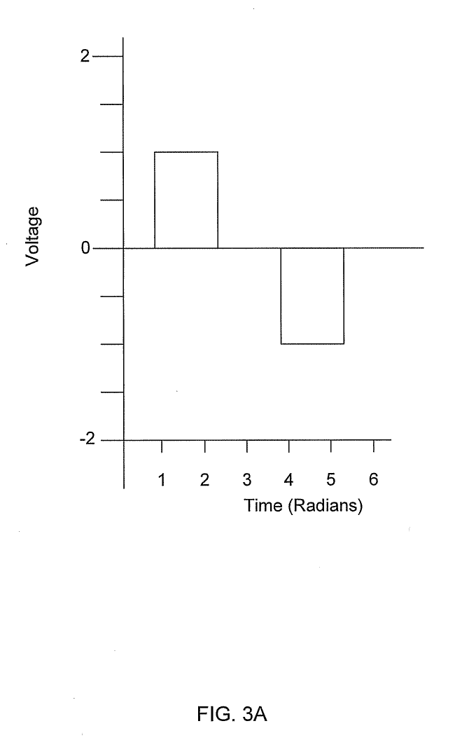

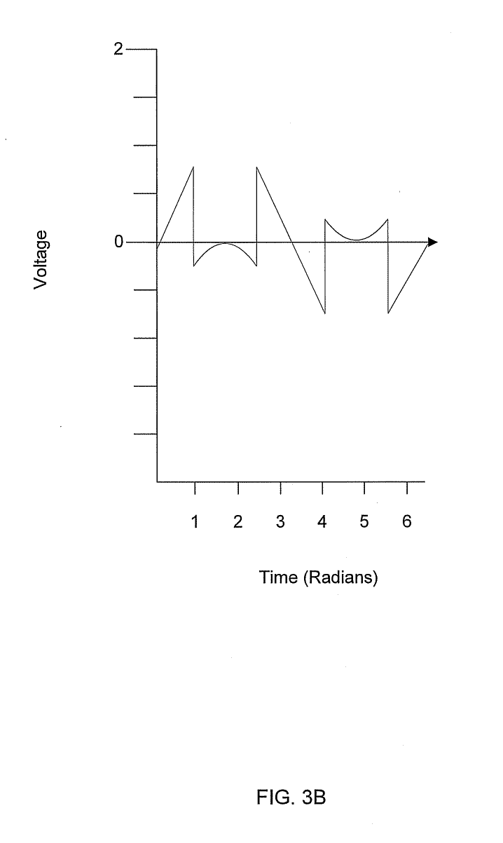

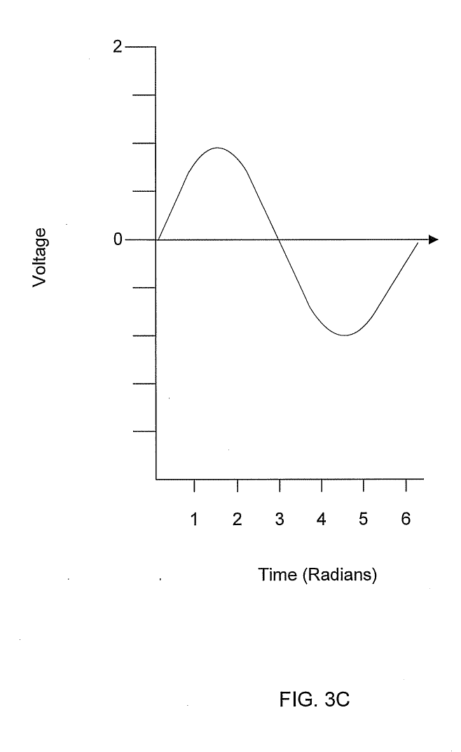

The operation of the circuit of FIGS. 1B and 1C will now be discussed with reference to FIGS. 3A-3C. The primary inverter produces an essentially square wave input to the transformer 114. To do this, switches 104 and 106 are connected to a secondary winding of the transformer, switches 110 and 112 are to another secondary winding of the transformer, and switches 113 and 114, forming the secondary inverter, are connected to the center-tapped primary winding of transformer 114.

The sequence of operation of the primary inverter is as follows. During the zero-output “dead time” phase of the primary waveform, switch 108 is closed and switches 104, 106, 110, and 112 are open. As discussed above, an alternate embodiment without switch 108 would be configured during this phase by closing switches 104 and 110 while switches 106 and 112 remain open. During the second, positive-output phase of the primary waveform, switches 106 and 110 are closed and the others are open. The third phase is identical to the first phase. The fourth and final, negative-output phase is generated by closing switches 104 and 112 and opening the other switches. In an inverter employing solid-state switches, the switches take a small increment of time to change state. If switches 106 and 104 are closed at the same time, or switches 110 and 112 are closed at the same time, an undesirably high-current will flow from the DC supply, wasting power and even possibly damaging the switches. One skilled in the art, familiar with solid switches, will recognize this problem as one of “shoot-through” currents. This problem is overcome, in the preferred solid-state embodiment of the primary inverter, by introducing a small period, on the order of a couple of microseconds, between each of the four phases described above, during which all switches are commanded to be open.

Switches 113 and 115 form the second inverter are connected to the primary winding of the inverter. The sequence of operation of the secondary inverter is more complex. It uses pulse-width modulation to produce a complex waveform exemplified by the graph of FIG. 3B. This waveform is not produced in the exact continuous form shown but rather approximated by a series of rectangular pulses, each comprising a positive phase and a negative phase. The relative width of the two phases is varied corresponding to the desired instantaneous voltage. That is, when the voltage is to be at zero, as it is at time 0 in the diagram, the duration of the positive and negative phases should be equal. When a maximum positive value is required, the duration of the positive phase is at maximum and the duration of the negative phase is at minimum. Likewise, a maximum negative value is produced with a minimum duration in the positive phase and maximum duration in the negative phase. For intermediate voltages, the relative durations of positive and negative phases are adjusted proportionately. During the positive phase of each pulse, switch 113 is on and switch 115 is off. During the negative phase, switch 115 is on and switch 113 is off. As with the primary inverter's switching sequence set forth above, the use of solid-state switches requires that a small period with both switches off be interposed between each positive phase and the subsequent negative phase and between each negative phase and the subsequent positive phase, to avoid wasteful shoot-through currents. The configuration of the primary inverter produces the output waveform of FIG. 3A, a simple square wave. The output of the secondary inverter approximates the waveform of 3B, and is essentially added to the waveform of 3A to produce the sine wave of FIG. 3C. In this way, the inverter of the present invention improves upon the design of a simple square wave inverter by addition two switches, and optionally an output filter, e.g., transformer 116 and rectifier 118.

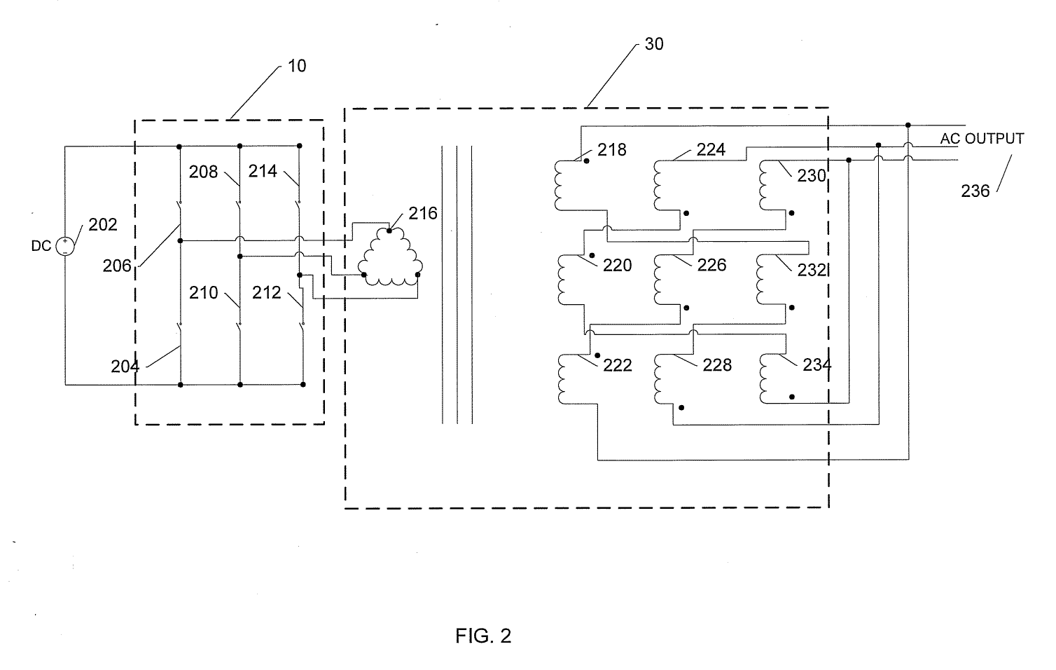

An embodiment of an inverter for supplying a three-phase AC output according to the invention is shown with reference to FIG. 2. It may not be immediately obvious that this embodiment, like the first, produces a first square waveform and adjusts it by the addition of a second correcting waveform because there is only one set of inverter switches in this second embodiment. The correction signal for each phase is concurrently produced by the same switches and adjusted in phase and amplitude by the specific interconnection and relative ratios of the auxiliary transformer secondaries of the other phases. This circuit includes a DC power supply 202, plurality of switches 204, 206, 208, 210, 212 and 214 forming a primary inverter, a poly-phase transformer 216 having a three phase primary winding, e.g., a delta configuration, and a plurality of secondary windings 218, 220, 222, 224, 226, 228, 230, 232 and 234. The square wave inverter uses the switches 204, 206, 208, 210, 212 and 214 to generate a square wave on each primary coil of the transformer, each square wave being a time shifted copy of each other square wave.

The switching sequence of the primary inverter for this embodiment will now be set forth. In the interest of simplifying the explanation to emphasize the essential operation of the inverter, the all-switches-off periods required for avoiding shoot-through, as explained for the first embodiment above, will not be included again but must be present for the reason explained above. The switches in the inverter operate in three pairs to produce the three phases of the waveform. The first pair, comprising switches 206 and 204, alternate between a positive state with switch 206 on and switch 204 off and a negative state in which switch 206 is off and 204 is on. The alternation occurs regularly at twice the line frequency. That is, for a 60 Hz output, the positive phase lasts 1/120 of a second and the negative phase lasts 1/120 second and this sequence repeats continuously with a period of 1/60 second. Operation of the second pair of switches, 208 and 210, is identical but shifted in time by 120 electrical degrees. For a 60 Hz line frequency, the second switch pair enters its positive state 1/180 second after the first pair enters its positive state. Likewise the transition of the third switch pair from negative to positive occurs 1/180 second after the negative-to-positive transition of the second switch pair. Because 3 times 1/180 second is 1/60 second or the period of the fundamental line frequency, the first switch will be again changing from negative to positive 1/180 second after the transition of the third pair. In this way, the primary inverter generates three AC waveforms at the line frequency with 120 degree relative phase.

Transformer 216, shown as a delta transformer though one skilled in the art will appreciate other transformer designs may also be used such as a plurality of N single-phase transformers, has N number of primary windings and each primary winding is coupled to N number of secondary coils. Importantly, in this configuration, as all of the power passes through the transformer, the circuit isolates the AC output from the DC input, in this way the inverter can be made to convert the voltage by adjusting all transformer ratios proportionately. For the three-phase circuit shown in FIG. 2, the transformer 216 has three primary windings with each primary winding having three secondary windings (218, 220, 222, 224, 226, 228, 230, 232 and 234), the ideal transformer ratios are:
1. Primary to first secondary of each phase 1000:476 (e.g. secondary windings 218, 224, 230);
2. Primary to second secondary of each phase 1000:242 (e.g. secondary windings 220, 226, 232); and
3. Primary to third secondary of each phase 1000:236 (e.g. secondary windings 222, 228, 234).

If a modified square wave designed inverter (not shown) is employed the duty cycle is 82%, and the optimum transformer ratios change to:
1. Primary to first secondary of each phase 1000:521 (e.g. secondary windings 218, 224, 230);
2. Primary to second secondary of each phase 1000:268 (e.g. secondary windings 220, 226, 232); and
3. Primary to third secondary of each phase 1000:268 (e.g. secondary windings 222, 228, 234).

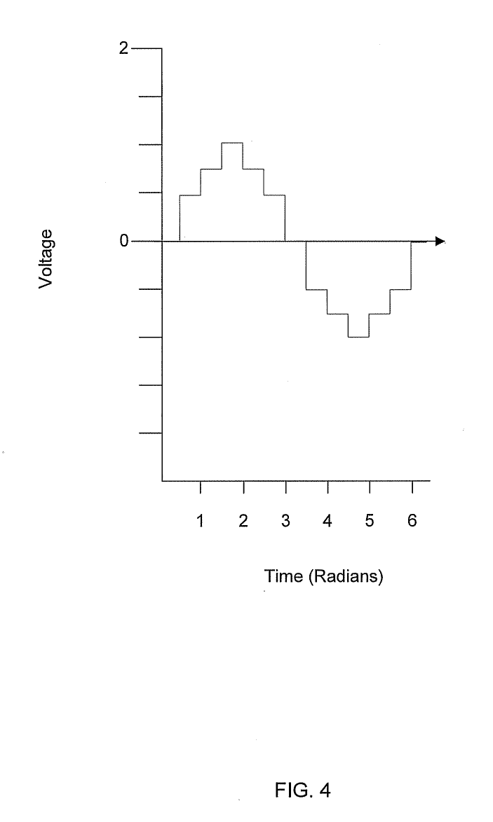

Using the circuit of FIG. 2, then, it is possible to create an inverter that employs only a square wave inverter, and no secondary inverter as in the circuit of FIG. 1. In such a configuration, the inverter outputs scaled copies of the time-shifted waveforms of other phases as the secondary, correcting waveform. An example of the output waveform for a single phase of the embodiment of FIG. 2 is shown in FIG. 4, and has a THD of approximately 17%.

As one skilled in the art will appreciate, a polyphase conversion system where the transformer based correction described is followed by an even smaller additional correction using a modulated carrier inverter as a secondary inverter, as shown in the embodiment of FIG. 1B, may also be constructed. If the efficiency of the transformer exceeds 97%, a single active secondary converter will likely be more efficient overall as well as being less complex than the embodiment of FIG. 2.

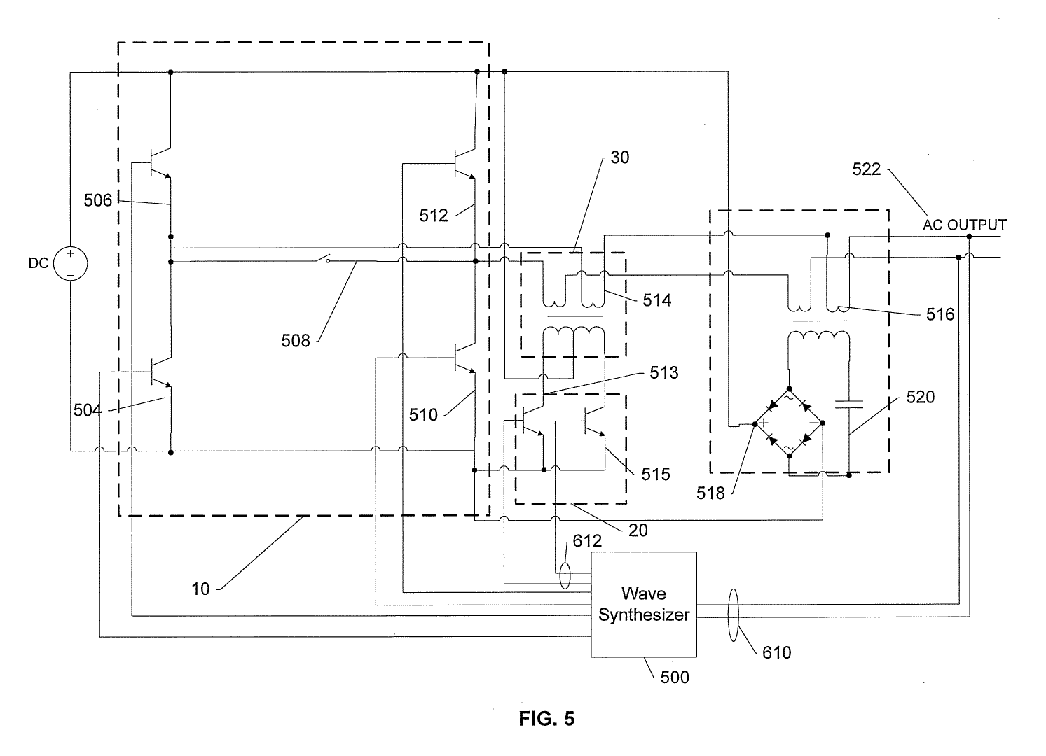

The secondary inverter taught herein adjusts the output of the primary inverter to the desired waveform, e.g., a sine wave, by adding to the output of the primary inverter a waveform that is, in the time domain, the difference between the primary inverter output waveform and the ideal desired output waveform or, in the frequency domain, comprises components with frequencies and amplitudes matching the undesired harmonics of the primary inverter output, but opposite in phase. In theory, the varying amplitudes of the correction waveform could be determined in advance and generated deterministically by a hardware look-up table or simple open-loop software program. However, this simplistic approach has distinct disadvantages, namely it would be beneficial to adjust the output waveform to counteract distortions introduced by a reactive or unbalanced load or even nonlinearities in the inverter itself, such as may be encountered in the buck-boost transformer. One method of addressing this is to implement the secondary inverter's controller as a computer controlled waveform synthesizer using closed-loop feedback. A computer-implemented embodiment is shown in FIGS. 5-8.

The basic circuit for a computer-implemented embodiment is shown in FIG. 5. This figure illustrates a single-phase embodiment but extending the implementation for three or more phases is as simple as duplicating the secondary synthesizer, buck-boost transformer, and inverter controller for each additional phase. As can be seen, the embodiment of FIG. 5 is similar to that of FIG. 1C, and as such includes a DC power source 502, a plurality of switches 504, 506, 508, 510, 512, 513 and 515, transformers 514 and 516, rectifier 518 and capacitor 520, all of which produces an AC output 522, in addition to waveform synthesizer 500. Switches 504, 506, 508, 510 and 512 form the primary inverter, while switches 513 and 515 form the secondary inverter, and are controlled by the waveform synthesizer 500, which is connected to, e.g., gates of IGBT transistors acting as the switches. The primary inverter operates at line frequency, e.g., 60 HZ, and outputs a modified square wave if switch 508 is closed during a zero output period of the waveform.

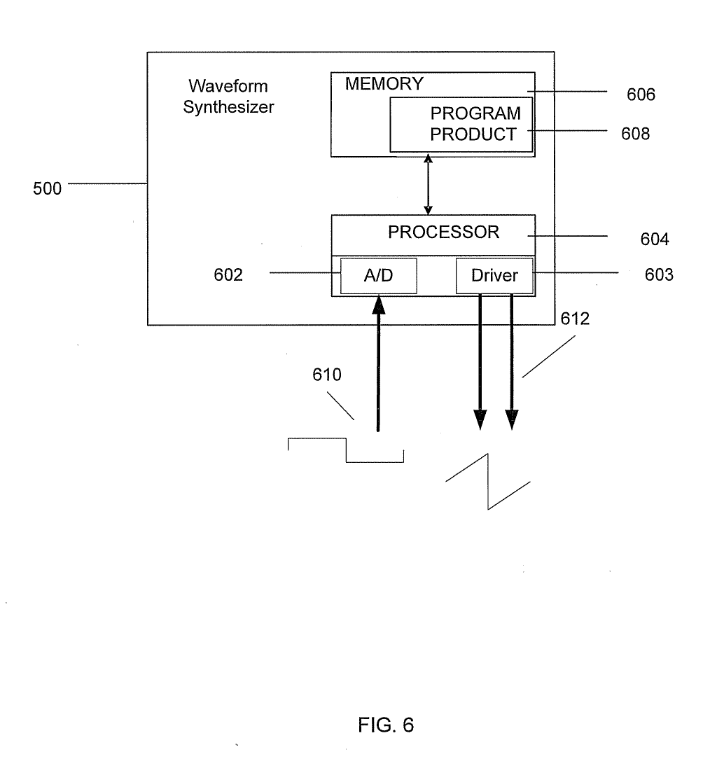

A waveform synthesizer 500 will now be described with reference to FIG. 6. The waveform synthesizer 500 comprises a memory 606, a program product 608, a processor 604, an analog-to-digital (A/D) and digital-to-analog (D/A) converter 602, and a pair of discrete outputs 612. For a bridge-type secondary inverter, four discrete outputs would be required. The analog-to-digital converter is connected to sample the output of the combined inverter and deliver to the processor a digital representation of the voltage at each instant in time. The sampling rate of the converter does not have to be the same as the modulating frequency of the secondary inverter, but accuracy will suffer if it is lower, there is little advantage to making it faster, and the details of programming will be simplified if it is the same. The analog-to-digital converter 602 may be implemented by any standard technique known in the art non-exclusively including successive-approximation, sigma-delta, single- or dual-slope integration, or voltage-to-frequency conversion. One of the first two is likely to be optimum in most situations. The detailed design of the discrete outputs 612 will depend on the nature of the switches. In practical embodiments, the outputs will comprise a totem-pole logic output (not shown), typically implemented on the die of the microcontroller or a peripheral integrated circuit. Logic level outputs will not be able to control most switches directly so there will need to be an interface circuit 603 to amplify and/or level-shift the logic signal to one suitable to drive the controlling electrode of the switches. The most common switches will be MOSFET or IGBT transistors and drivers for both types of device are widely available as integrated circuits such as the Ixys IXDR502 MOSFET gate driver or as complete modules such as the VLA500 series of IGBT gate drivers offered by Powerex. Moreover, depending upon the implementation of the various embodiments, the driver 603 may control additional gates for the primary inverter switches, and though the output signals for these switches are not explicitly shown in FIG. 6, such an embodiment is within the scope of this disclosure.

As can be seen, the analog-to-digital converter 602 and the discrete outputs 612 are connected to the processor 604 along with memory 606. These subsystems may be separate devices embodied in a plurality of specific integrated circuits. The CPU might be a microprocessor or a special-purpose stored-program processor built from a gate array or even a hard-wired logic system. The memory can be discrete memory ICs of various technologies. The A/D and discrete outputs may be embodied in IC devices with these specific functions. However, it is sufficient and preferred to use a single integrated microcontroller with the functions of CPU, program storage, data memory, analog input, and discrete outputs all combined in a single integrated circuit. Many suitable microcontrollers are available from numerous manufacturers including the PIC32MX6xx series available from Microchip Technologies or the AT32UC3 series from Atmel. Many such devices, including the Microchip part cited above, offer on-chip pulse-width modulation components which can simplify the process of developing the program product. Processor 604 is the “brains” of the waveform synthesizer 500, and as such executes program product 608. The program must command the switches of the secondary inverter to open and close to produce the varying-width pulses described above according to a time-sampled representation of the waveform maintained in memory 606. Concurrently, the program must read the voltage values from A/D converter 603, compare them to the desired output waveform, and make adjustments to the time-sampled representation of the output. As one skilled in the art will appreciate, processor 604 may also have sufficient capacity to concurrently control the much simpler timing of the primary inverter switches and may include components that allow the waveform synthesizer 500 to be connected to user interface means [not shown] such as a display and keyboard that would allow a user to monitor operation and adjust parameters or to a network interface which would allow a remote user or higher-level automated system to similarly monitor and control the operation of the inverter.

Memory 606 may store several processing and waveform generation algorithms as well as the time-sampled representations of the current secondary inverter output waveform, the overall inverter output, and a template for the desired, sinusoidal, output. Additionally it will store variables used by the particular algorithm. In many microcontrollers intended for such digital signal processing, the program storage and the data memory are logically separate rather than a single array such as used the Van Neuman architecture found in general purpose computers. As such, memory 606 may consists of both non-volatile memory, e.g., flash memory, masked-ROM, EPROM, and the like, and volatile memory, e.g., SRAM, DRAM, SDRAM, etc., as required by embodiments of the instant invention.

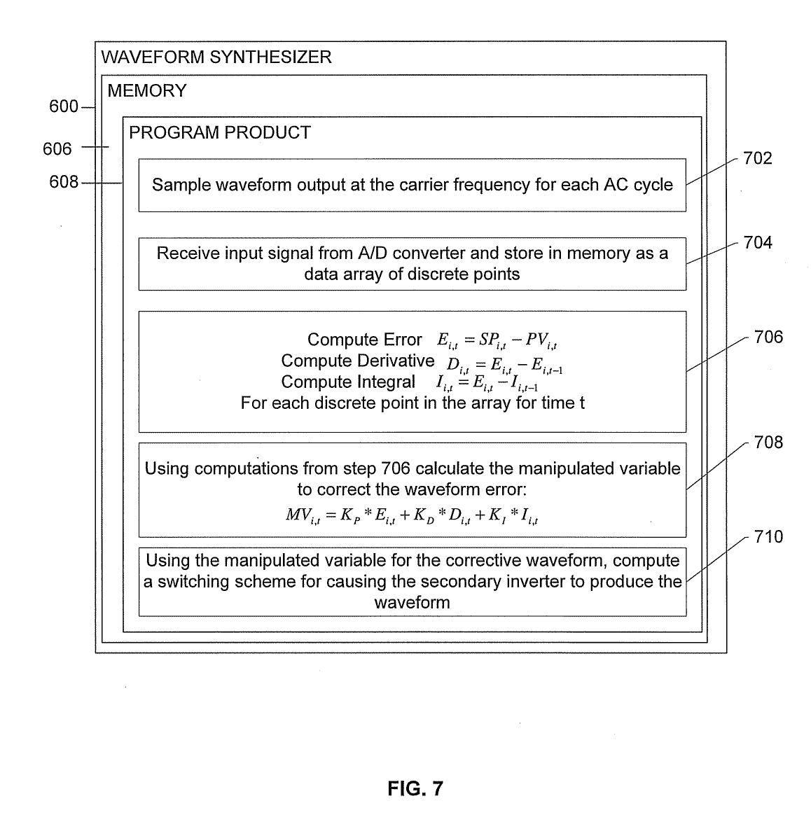

Program product 608 processes the waveform data and produces a corrective waveform which determines the widths of the pulses driving the switches of the secondary inverter ultimately resulting in sending the analogous electrical waveform to the primary of the buck-boost transformer, described herein below with reference to FIG. 7. To do this, the waveform output from the circuit is input into the waveform synthesizer (step 702). As one skilled in the art will appreciate, the waveform may incorporate a circuit, or digital signal processor (DSP), that is capable of reading analog voltages and operates similar to, e.g., an oscilloscope. Such a circuit may include A/D converters in combination with digital signal processing algorithms that are known in the art to convert measured voltages into digital representations of the voltage measurements and to store these measurements as a data array in memory (step 704). Then, the digital signal is compared to an ideal sine wave to produce a time-sampled representation of the error, comprised of an error, derivative and integral calculation for each discrete time t (step 706). After the error, derivative and integral are computer, the manipulated variable to correct the waveform error is computed for each data point, and a correction waveform is constructed (step 708). The program product then controls the DSP to dynamically adjust the waveform simulator to generate a secondary inverter signal that, when input into the transformer 516, produces a sine wave without the computed error (step 710).

To adjust the waveform required to correct the error between the output and an ideal sine wave, the program product 608 uses a novel form of the standard PID algorithm. As is known in the art, a PID (or “proportional”, “integral”, “derivative”) algorithm has as inputs a setpoint (SP) specifying the desired output of the system and a measured value or variable (PV), which is the actual output of the system. The output of the PID algorithm is the manipulated variable (MV) and this value controls whatever means is producing the output of the system to form a feedback loop. The PID algorithm internally computes an error value and an integral and derivative of this error value with respect to time. To compute the PID algorithm, each of these three values is multiplied by a respective constant (called tuning parameters), and the products are summed to obtain the value for the manipulated variable. Thus, for the PID algorithm:

The proportional term is given by:

Pₒᵤₜ=Kₚe(t) (Eq. 1.1)

where,
Pₒᵤₜ: Proportional term of output
Kₚ: Proportional gain, a tuning parameter
e: Error=SP−PV
t: Time or instantaneous time (the present);

The integral term is given by:

$${I}_{out} = {K}_{i} {\int }_{0}^{t} e ( τ ) d τ \qquad ( Eq . 2.1 )$$

where,
Iₒᵤₜ: Integral term of output
Kᵢ: Integral gain, a tuning parameter
e: Error=SP−PV
t: Time or instantaneous time (the present)
τ: a dummy integration variable; and

The derivative term is given by:

$${D}_{out} = {K}_{d} \frac{d}{d t} e ( t ) \qquad ( Eq . 3.1 )$$

where,
Dₒᵤₜ: Derivative term of output
K_{d}: Derivative gain, a tuning parameter
e: Error=SP−PV
t: Time or instantaneous time (the present).

As one skilled in the art will recognize, the algorithm may be implemented in discrete time steps. For each discrete time period t, the equations above reduce to:

Eₜ=SPₜ−PVₜ(the error term); (Eq. 1.2)

Dₜ=Eₜ−Eₜ₋₁(the derivative); (Eq. 2.2)

Iₜ=Eₜ−Iₜ₋₁(the integral); (Eq. 3.2)

and

MVₜ=K_{P}*Eₜ+K_{D}*Dₜ+K_{I}*Iₜ(the manipulated variable, MV) (Eq. 4.1).

In the invention, the program product 608 is programmed to compute a novel PID algorithm, based on the known equations above, that has inputs, outputs and internal variables each replaced with one cycle of a periodic waveform. Preferably, these waveforms are measured, stored, and manipulated as an array of discrete time-sampled amplitudes, i.e., digitized according to known processing techniques for, e.g., digital oscilloscopes. As one skilled in the art will appreciate, depending upon the number of datapoints sampled in the waveform reading, the digitized amplitude readings from the A/D 602 may be stored in a “dense” array.

The program product 608 is programmed to compute a novel vector PID algorithm by applying scalar PID computations to data arrays representing a waveform sample for each sampling time period. As such, each array has N values, where N is the number of sampling periods in the period of the waveform, i.e., the sampling frequency divided by the system frequency. To compute the vector PID, the following are calculated for each array index i, i=(1, 2, 3 . . . N), at each time interval t. That is, the program product performs the following calculations, either sequentially or in parallel, N times for each sampling period.

E_{i,t}=SP_{i,t}−PV_{i,t}(the error term); (Eq. 1.3)

D_{i,t}=E_{i,t}−E_{i,t-1}(the derivative); (Eq. 2.3)

I_{i,t}=E_{i,t}−I_{i,t-1}(the integral); (Eq. 3.3)

and

MV_{i,t}=Kₚ*E_{i,t}+K_{D}*D_{i,t}+K_{I}*I_{i,t}(the manipulated variable, MV) (Eq. 4.2).

The computer program product 608 may also be programmed to include additional bounding parameters for the equations above. For example, limits on the integral term, freezing the integrator when the MV is at its minimum or maximum value, computing the integral term over a limited number of past samples, computing the derivative based upon the MV rather than the error, or making the tuning constants, K, be functions of the setpoint value, can all be integrated into the program product to further refine the techniques disclosed herein.

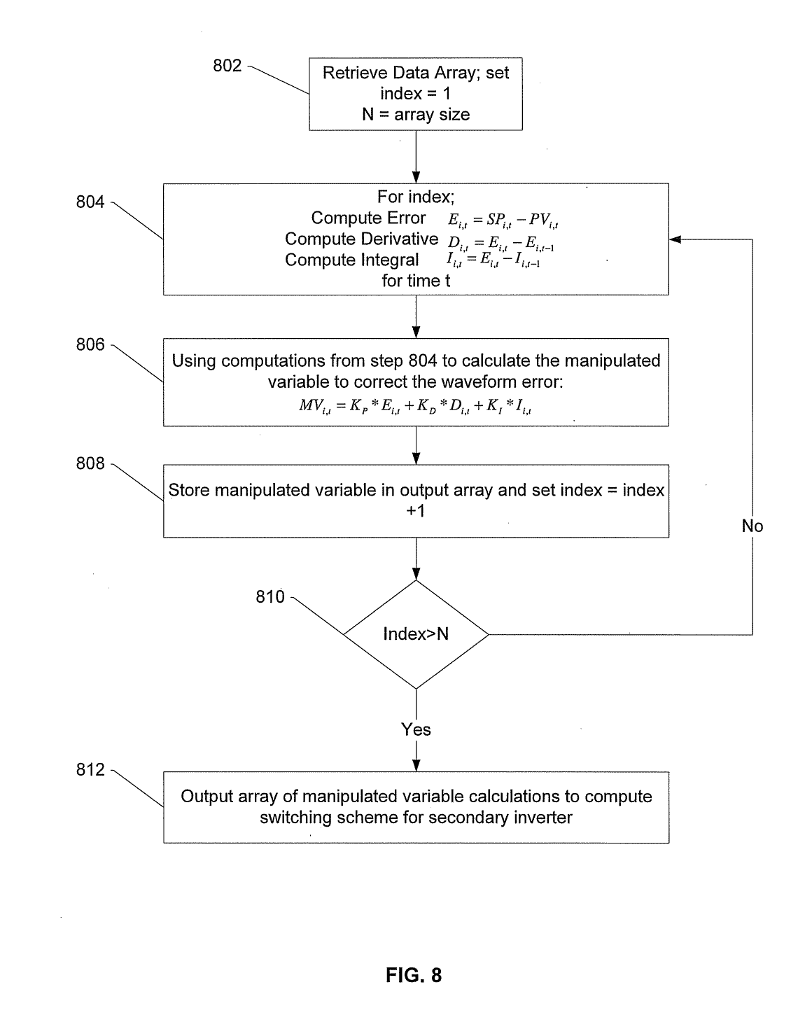

As one skilled in the art will appreciate, equations 1.3, 2.3, 3.3 and 4.2 can be expressed as computer code programmed into computer program product 608. A diagram of the software flow is shown in FIG. 8. As can be seen, the program product assigns an index as 1, and sets a value N as equal to the size of the data array from the A/D converter (step 802). For the index value, the error, derivative, and integral are computed for time t, or the time in which the data point was observed (step 804). These values are a function of the setpoint (or desired output) minus the actual observed data point. As such, this portion of the program product compares the desired output waveform from the transformer to the actual output waveform. Using the computations from step 804, the program product then calculates the manipulated variable MV, to correct the observed output data point (step 806). Then, the manipulated variable in the output array is saved, and the index is incremented (step 808), and if the index is not greater than N, the MV for the next observed datapoint is computed (step 810). If the index is greater than the number of N, a switching scheme for the secondary inverter switches is implemented that produces an output waveform corresponding to the MV output array (step 812).

The following exemplary code (shown herein written in the C language, though other programming languages can be used) may process the data array to generate a corrective waveform:

/*
* Vector PID Algorithm
*/
# define SAMPLES_PER_CYCLE 100
float Setpoint [SAMPLES_PER_CYCLE],

PV [SAMPLES_PER_CYLCE],
Error [SAMPLES_PER_CYLCE],
PrevError [SAMPLES_PER_CYLCE],
Integral [SAMPLES_PER_CYLCE],
Derivative [SAMPLES_PER_CYLCE],
MV[SAMPLES_PER_CYLCE],

float Kp , Kd , Ki ;
void Initialize (void)
{

```
  int i;
  for (i = 0; i< SMAPLES_PER_CYCLE; i++) {
```

PrevError [i] = 0;
Integral [i] = 0;

}
// Set tuning parameters Kp, Kd, and Ki to application-specific values
}
/*
* An example Setpoint - a sine waveform with RMS amplitude 1
*/
void createSetpoint (void)
{

```
  int i;
  for (i=0; i< SAMPLES_PER_CYLCE; i++) {
```

Error[i] = Setpoint[i] − PV [i];
Integral [i] += Error[i];
Derivative[i] = Error[i] − PrevError[i];
MV[i] = Kp * Error[i] + Ki * Integral[i] + Kd * Derivative[i];
PrevError[i] = Error[i];

}

}
void main (void)
{

```
  Initialize ( );
  CreateSetpoint ( );
  for (;;){
  //Measure output (i.e. inverter output voltage) and place in PV
```

VectorPID( );

```
  // Send MV values to control system output means (i.e. PWM
  modulator)
  }
```

}

Once the MV, or desired output of the system, is determined, the computer program product generates a new corrective waveform. To convert the numerical representation of the waveform into an analogous electrical signal, the computer program product uses, e.g., digital signal processing techniques to generate a digitized version of the desired waveform MV and a PWM algorithm, PWM hardware, or other digital-to-analog (D/A) converter to convert the digitized signal to the desired analog output 536.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification.

That claimed is:

1. An inverter circuit to generate an AC output from a DC input, the inverter comprising:
a combining circuit to combine a first and second signal;
a primary inverter receiving a DC input and generating the first signal to input into the combining circuit, the primary inverter comprised of a plurality of switches that when actuated produce the first signal, the first signal being an approximation of a sine wave that has an error component; and
a secondary inverter receiving the first signal with the error component and formulating the second signal, the secondary inverter using a plurality of secondary inverter switches to modulate the second signal for input to the combining circuit, the second signal attenuating the error component of the first signal to thereby producing an AC output that is substantially a sine wave.

2. An inverter circuit of claim 1, further comprising:
a filter connected to the output of the combining circuit for attenuating residual energy of a carrier frequency of the second signal generated by the secondary inverter.

3. An inverter circuit of claim 2, wherein the filter comprises a rectifier, the rectifier being connected to the DC input of the primary inverter.

4. An inverter circuit of claim 1, wherein the combining circuit is a buck-boost transformer.

5. An inverter circuit of claim 1, wherein the circuit further comprises:
a transformer, the transformer receiving the combined output signal from combining circuit, and
a rectifier, connected to the secondary of the transformer,
wherein the transformer and rectifier operate to attenuate residual energy at the carrier frequency of the secondary signal generated secondary inverter.

6. An inverter circuit of claim 1, wherein the primary inverter consists of at least four switches, and each of the switches operates to generate a square wave or modified square wave for the first portion of the input into the combining circuit.

7. An inverter circuit of claim 6, wherein the secondary inverter is comprised of solid-state transistors.

8. An inverter circuit of claim 7, wherein the transistors in the secondary inverter are connected in a push/pull configuration.

9. An inverter circuit of claim 8, wherein the solid state transistors are selected from one of IGBT transistors or MOSFET transistors.

10. An inverter circuit of claim 1, wherein the secondary inverter operates at a carrier frequency range of 5 KHz to 20 KHz.

11. An inverter circuit for generating a three-phase AC output from a DC input, the inverter comprising:
a three-phase transformer for receiving an input signal, the three-phase transformer receiving the input signal across three primary windings;
a primary inverter for generating the input signal, the primary inverter connected to the DC input and using switches that when actuated produce the input signal, the input signal being an approximation of a sine wave, the approximation of the sine wave having an error component;
a plurality of secondary windings for each phase of the three-phase signal, each phase having at least three such secondary windings, each of the three secondary windings generating a different output from each of the other three secondary windings which, when combined in an electrical series, result in a combined output that is an improved approximation of the sine wave.

12. An inverter circuit of claim 11, wherein the primary inverter comprises six switches, the six switches generating a square wave input to the primary windings of the transformer.

13. An inverter circuit of claim 12, wherein the switches are transistors, the transistors being selected from IGBT transistors or MOSFET transistors.

14. An inverter circuit of claim 13, wherein a total harmonic distortion for the AC output signal is equal to or less than 17%.

15. An inverter circuit of claim 11, wherein the primary inverter is a square wave inverter and primary winding to secondary winding ratios for each phase are primary to a first secondary of each phase 1000:476, primary to a second secondary of each phase 1000:242; and primary to third secondary of each phase 1000:236.

16. An inverter circuit of claim 11, wherein the primary inverter is a modified square wave inverter and a primary winding to secondary winding ratios for each phase are primary to a first secondary of each phase 1000:521, primary to a second secondary of each phase 1000:268; and primary to third secondary of each phase 1000:268.

17. An inverter circuit of claim 16, wherein a total harmonic distortion for the AC output signal is equal to or less than 17%.

18. An inverter circuit to generate an AC output from a DC input, the inverter comprising:
a transformer to combine a first and second signal, the transformer having primary and secondary windings, a center tap of the primary winding being connected to the DC input;
a primary inverter receiving the DC input and generating the first signal to input into the combining circuit, the primary inverter comprised of at least four solid state switches that when actuated produce the first signal, the first signal being a square wave;
a secondary inverter receiving the first signal and formulating the second signal, the secondary inverter using at least twp secondary inverter switches to modulate the second signal for input to the transistor, the second signal adding to the first signal to thereby producing an AC output that is substantially a sine wave; and
a filter connected to the output of the transformer, the filter comprising:
a second transformer receiving the output from the first transformer; and
a rectifier connected to the secondary of the second transformer,
wherein the transformer and rectifier operate to attenuate residual energy at the carrier frequency of the secondary signal generated secondary inverter.

19. The inverter circuit of claim 18, wherein the second transformer is a buck boost transformer.

20. The inverter circuit of claim 18, wherein the secondary inverter operates at a carrier frequency range of 5 KHz to 20 KHz.
